(19) United States
(12) Patent Application Publication
(10) Pub. No.: US 2023/0062396 A1
(43) Pub. Date: Mar. 2, 2023

(54) FLOAT VALVE, COMPRESSED-AIR SYSTEM HAVING A FLOAT VALVE, AND DRIER FOR A COMPRESSED-AIR SYSTEM HAVING A FLOAT VALVE

(71) Applicant: DÜRR DENTAL SE, Bietigheim-Bissingen (DE)

(72) Inventors: Tobias NAGELE, Mundelsheim (DE); Thomas BUCHELE, Ohringen (DE)

(73) Assignee: DÜRR DENTAL SE, Bietigheim-Bissingen (DE)

(21) Appl. No.: 17/755,974

(22) PCT Filed: Nov. 10, 2020
(86) PCT No.: PCT/EP2020/081609

§ 371 Date: Oct. 24, 2022

(30) Foreign Application Priority Data
Nov. 14, 2019 (DE) 10 2019 130 798.8

(51) Int. Cl. F16K 24/04; B01D 53/26; F16K 31/22; F16K 7/18

(52) U.S. Cl. CPC F16K 24/042; B01D 53/26; F16K 31/22; F16K 7/18

(57) ABSTRACT

A float valve, in particular for draining condensate in a medical compressed-air system, including: a float; a valve seat, which defines a valve opening having a valve opening cross-sectional area q_{A}; and a closure element for opening and closing the valve opening cross-sectional area q_{A} of the valve opening. The closure element can be controlled by means of the float between a completely open position X and a completely closed position Y. The closure element is elastic and is part of a partial opening mechanism, which is designed to successively open the valve opening cross-sectional area q_{A} of the valve opening between the completely closed position Y and the completely open position X as a result of the elasticity of the closure element.

### BACKGROUND OF THE INVENTION

### 1. Field of the Invention

The invention relates to a float valve, a compressed air system having a float valve, and a dryer for a compressed air system having a float valve.

### 2. Description of the State of the Art

Float valves are often used to drain liquids, for example condensate from a compressed air system. In this context, the float valve usually has a valve seat which forms a valve opening. Moreover, for switching the valve, a movable closure element is often provided which cooperates with the valve seat and opens or closes the valve opening in a sealing manner. For this purpose, a float controls the closure element via various types of control mechanisms.

In this connection, the float can be arranged in a housing together with the other valve components. But it can also be arranged outside of such a housing in a collection container or the like, such as, for example, in the case of the tank of a toilet flushing mechanism, and act from its position there on the closure element via a corresponding control mechanism.

The accumulation of liquid causes a buoyancy force to act on the float which is available to the control mechanism to lift the closure element off the valve seat.

In the case of compressed air systems, however, a relatively high opening force is required to open the closure element. This is because the overpressure, which is present in the compressed air system, usually creates a not insignificant pressure difference at the closure element and/or in the area of the valve opening of the closure element. As a result, very large floats would have to be provided which generate a sufficient buoyancy force.

For this reason, up to now, control mechanisms have been used in the state of the art for such compressed air systems, in particular in the medical field, and above all in the dental field as well, which, for example, strongly translate the buoyancy force by means of a lever mechanism, in order to exert the necessary opening force on the closure element.

But the float valves of this type have the disadvantage that many components are required which must be precisely matched to each other. In addition to that, a long movement path of the float is necessary which, depending on the installation situation in the compressed air system, cannot be provided.

Another solution in the State of the Art comprises a control mechanism with a pneumatic pilot control, in which a small pilot valve is first opened, in order to use compressed air from the compressed air system to control the actual closure element.

Apart from the complex production of such a float valve, said pilot control has the disadvantage that the small pilot valve is susceptible to clogging by small particles, which causes the float valve either to open permanently or not to open at all, depending on the location of the particle entrapment.

### SUMMARY OF THE INVENTION

It is therefore the task of the invention to provide a float valve which takes into account the above considerations regarding the State of the Art and, in particular, has a simpler structure than the float valves known in the State of the Art.

### BRIEF DESCRIPTION OF THE DRAWINGS

Said task is solved by a float valve, in particular for draining condensate in a medical compressed air system, comprising:

a) a float;

b) a valve seat, which defines a valve opening having a valve opening cross sectional area q_{A}; and

c) a closure element for opening and closing the valve opening cross sectional area q_{A} of the valve opening, wherein the closure element can be controlled by means of the float between a completely open position X and a completely closed position Y.

According to the invention, the closure element is elastic and is part of a partial opening mechanism which is designed to successively open the valve opening cross sectional area q_{A} of the valve opening between the completely closed position Y and the completely open position X as a result of the elasticity of the closure element.

The inventors have recognized that the elasticity of the closure element and the partial opening mechanism make it possible that it is not the entire valve opening cross-sectional area q_{A}, which is opened abruptly, when the valve opening is opened. Due to the elasticity of the closure element and due to the partial opening mechanism, the valve opening cross sectional area q_{A} of the valve opening opens successively, that means gradually, instead. In this way, the elastic closure element is lifted off the valve seat in a “peeling” movement.

This has the advantage that the opening forces, which have to be applied to open the valve opening, are reduced compared with the immediate opening of the entire valve opening cross-sectional area q_{A}.

Since the opening force required for opening the valve opening according to

F=≢p*A

is mainly determined by the pressure difference at the closure element and the area to be opened, a smaller area to be opened is advantageous, in order to open the closure element already with low opening forces despite a high-pressure difference.

Above all, in a compressed air system, the pressure difference can substantially occur as the difference between the pressure, which is applied in the flow line arranged downstream of the closure element, and the pressure, which acts directly on the closure element by the fluid to be drained, for example, condensate, usually from above. This is the case with medical compressed air systems, where the float valve must in addition comply with strict hygiene regulations (for example, lower number of particles and lower oil content in the compressed air), so that complex mechanisms, which may require lubrication, are excluded.

In addition, in most cases, the weight force of the float, which may preferably be made of a foamed material, for example, a particle foam, and of the closure element, also counteracts the opening of the closure element, since the float and the closure element are usually aligned substantially vertically in the closed state of the float valve, and are opened with at least a vertical opening direction component.

The pressure in the flow line, which is located downstream of the closure element, is substantially the same as the ambient pressure when the valve opening is closed.

The pressure acting directly on the closure element from the liquid to be drained includes on the one hand the hydraulic pressure of the liquid to be drained which is determined by the height of the water column prevailing at the closure element. But on the other hand, the pressure above the liquid to be drained also has an effect. In a usual compressed air system, said pressure is approx. 5 bar up to approx. 10 bar, which is generally considerably higher than the ambient pressure, since the area above the liquid level is usually connected directly or indirectly to a pressure line of the pressure system.

The explained pressure difference, taking into account the relevant surfaces of the closure element, results in the closure force, which acts on the closure element in the closed state of the float valve. The valve opening force is in turn the force, which must be exerted on the closure element, in order to overcome the explained closure force.

If, as provided by the invention, only a partial area of the valve opening cross sectional area q_{A} is opened at one moment, only a part of the total valve opening force must be exerted on the closure element, in order to open said partial area of the valve opening cross sectional area q_{A}. As soon as a smaller part of the valve opening cross sectional area in relation to the total valve opening cross sectional area has been opened, the liquid to be drained already flows out via said partial area of the valve opening cross sectional area.

The resulting partial pressure equalization across the opened partial area of the valve opening can reduce the pressure difference, as a result of which the opening force required to open the remaining valve opening cross sectional area is reduced further.

In pressureless systems, substantially only the hydraulic pressure of the liquid to be drained, for example, the condensate, acts on the closure element. In addition, as it has already been described, the weight force of the float and the of the closure element counteracts the opening of the closure element. In this way, the valve opening forces to be applied to open the closure element are lower in pressureless systems than in pressure systems. But the float valve according to the invention works for both systems.

In addition to that, the lower opening forces for opening the closure element allow the valve opening cross sectional area q_{A} to be increased by using a conventional float known in the State of the Art. A larger valve opening cross sectional area q_{A} has the advantage that it is less sensitive to particles which might possibly enter the valve.

Elastic is generally understood to mean the property of a material, which allows it to undergo deformation of the material, for example, bending or curvature, by applying forces, for example, by pushing or pulling, and to return substantially to its original state after the forces have ceased.

Above all, for the present invention, the elasticity of the closure element allows that during opening of the closure element, the closure element is deformable in such a way that areas of the closure element are movable different from the remaining areas of the closure element. In particular, the elasticity shall be selected in such a way that one area of the closure element can already be lifted off the valve seat, in order to open a partial area of the valve cross sectional area, while another area still closes another part of the valve cross sectional area. Preferably, one area of the closure element can be moved in a plane different from the other areas of the closure element. But it is also imaginable to carry out a superimposed movement of the area of the closure element in several planes.

The elastic closure element can preferably be made out of an elastomer. But it is also imaginable that the elastic closure element is made out of a different material such as, for example, a thermoplastic or a thin sheet of spring steel.

The closure element can preferably be directly connected to the float. In this context, the closure element can preferably be materially connected to the float, for example, as an elastic layer vulcanized or bonded to the float. Alternatively, the closure element can also be materially or frictionally connected to the float by means of at least one retaining means attached to the float or to another interposed element. In this way, the closure element can also cooperate directly with the float, in order to form the partial opening mechanism.

Alternatively, the closure element can be indirectly connected to the float via further component parts and interact with the float. For example, a resilient, sheet metal like element, to which the closure element is attached, would be imaginable. By means of the resilient, sheet metal like element, vibrations of the float can be better cushioned.

A fully opened position X is understood to be a position of the closure element, in which the closure element constitutes substantially no flow resistance, or at least a lower flow resistance compared with the other flow resistances, to the liquid to be drained.

A fully closed position Y is understood to be a position of the closure element, in which the valve opening is substantially sealed by means of the closure element, so that there is substantially no exchange of medium between the environment and the medium to be released.

By successive opening of the valve opening cross sectional area q_{A} of the valve opening, a partial cross section of the valve opening cross sectional area q_{A} of the valve opening is meant, which increases with the movement of the closure element between the fully closed position Y and the fully opened position X, while another partial cross section of the valve opening cross sectional area q_{A} is not yet opened.

Preferably, the valve opening cross sectional area q_{A} can have two partial cross sections here, a first opened partial cross section and a second not opened partial cross section. When moving the closure element between the fully closed position Y and the fully opened position X, the first partial cross section becomes larger, while the second partial cross section becomes smaller.

Further aspects of the invention result from the dependent patent claims explained below.

Preferably, the elastic closure element may comprise, at least in sections, a strap for opening and closing the valve opening cross sectional area q_{A} of the valve opening, the strap being designed to be removed from the valve opening in a peeling manner between the fully closed position Y and the fully opened position X, in order to successively open the valve opening cross sectional area q_{A} of the valve opening by the removal in a peeling manner.

In this connection, the above mentioned partial opening mechanism includes the strap and the strap is the closure element at the same time. For this purpose, the strap can be laid twice over the valve opening like a loop, wherein, by pulling the upper part of the strap lying in the loop, automatically the removal in a peeling manner of the strap for successive opening of the valve opening cross sectional area q_{A} of the valve opening results.

Preferably, in the fully closed position Y and in the fully opened position X, the strap is arranged in a substantially concentric manner with respect to the valve opening. Alternatively, however, the strap may as well be arranged in an eccentrical manner with respect to the valve opening in the fully closed position Y and in the fully opened position X. It would also be imaginable to arrange the strap in such a way that the strap is substantially concentric with respect to the valve opening in the fully closed position Y and eccentric with respect to the valve opening in the fully opened position X, or vice versa.

The strap can preferably be designed in such a way that the strap has resilient properties, in order to cushion in this way vibrations of the float even without the aid of additional damping elements. This enables a smooth opening and closing of the float valve. This in turn reduces noise and mechanical stress in the float valve.

Furthermore, the resilient properties of the strap cause an at least partial compensation of the weight force of the float. By this, the valve opening force required to open the closure element is further reduced. As a result, the float valve can be opened even at lower liquid levels and/or with smaller floats.

In this connection, the strap may have a thickness, which is equal to or greater than a diameter of the valve opening, in order to cover and close at least the entire valve opening in the fully closed position Y.

Another advantage of the strap is that the strap can compensate for possible tolerances between the valve seat and the float. In this way, an exact guidance of the float and the closure element can be dispensed with. By this, the design of the float valve is still further simplified.

Preferably, a retaining means each can be provided on the float and/or on the valve seat, by means of which the strap can be attached to the float and/or to the valve seat.

This allows the strap to be positioned more precisely on the valve seat, in particular when closing the closure element, in order to improve the closing function and thus the tightness of the closure element on the valve seat. A corresponding mating retaining means can be molded onto the strap.

The retaining means can be arranged in a concentrical manner with respect to the valve opening, for example, centrally in a circular valve opening. In this case, the retaining means can be connected to the material of the valve seat by means of one web or by means of several webs.

Alternatively, the retaining means may be arranged in an eccentric manner with respect to the valve opening, for example, at a distance of less than approx. 5 cm from the centre of the valve opening. In this context, the term ‘at the valve seat’ also includes the immediate vicinity of the valve seat, for example, at a distance of approx. 3 cm from the outer edge of the valve opening.

The retaining means can also be provided only on the float. In this case, the area of the strap facing the valve seat is free and can therefore be moved, also independently of the valve seat.

The retaining means can preferably form a positive connection to the strap, for example, as an annular element which receives the strap by positive locking. But the retaining element can also be a retaining means that does not require an additional component, but is formed by the strap, the float or the valve seat, or a combination of these three components. For example, the strap can be fused onto the valve seat and/or onto the float and thus effect a material connection to the valve seat and/or to the float.

Preferably, the strap is a closed strap.

In this connection, the strap can preferably have a uniform cross section. But a non uniform cross section is also imaginable. The non uniformity may consist, for example, in the fact that the strap has stiffening areas or areas for attaching the strap which differ from the other areas with regard to the cross section. Such stiffening areas or areas for attaching the strap can be provided in particular in the vicinity of the float and/or in the vicinity of the valve seat.

Generally, it is to be noted with regard to the strap shaped closure element that the strap shaped closure element can be designed to act as a spring due to its shape, its material property and/or its attachment. For example, this can make the float valve less sensitive to fluctuations in the liquid level. But it can also be ensured in this way that from a predetermined lower position of the float, the float valve remains closed in any case, if the strap has such a spring effect that from this position it presses against the valve seat.

In one embodiment, the closure element can be positioned eccentrically to the valve opening at least in the fully closed position Y, and can be attached to the float in such a non-uniform manner that, when the closure element is controlled between the fully closed position Y and the fully opened position X, the closure element is removed from the valve opening in a peeling manner, and the valve opening cross sectional area q_{A} of the valve opening can be successively opened by the removal in a peeling manner.

In said embodiment, the above-mentioned partial opening mechanism is significantly formed by the non-uniform attachment of the elastic closure element to the float. A non-uniform attachment of the elastic closure element to the float is an attachment of the elastic closure element to the float in one area, with the remaining area of the elastic closure element not being attached to the float.

As a result, the opening force of the closure element, which is caused by the buoyancy force of the liquid to be drained on the float, acts only on the attached areas of the closure element. The remaining area experiences no, or at least, lower opening forces than the attached area.

As a result, at the beginning of the opening process, only the partial area of the valve opening cross sectional area, which is closed by the attached area of the closure element in the closed state of the closure element, is opened. The remaining unattached area initially remains closed, and is only opened in the course of the further opening process. As a result, the valve opening cross sectional area q_{A} is successively opened.

The eccentric positioning of the closure element for the valve opening further reduces the necessary opening force.

The attachment can also be present on several areas of the closure element.

The closure element can preferably be attached to the float in a non positive manner, for example by means of an interference fit, or in a positive manner, for example, by gluing or fusing. Furthermore, the closure element can be attached indirectly, that means, not directly, or directly to the float.

In one embodiment, the valve opening has several cross sectional regions of different size, wherein the closure element can be peeled off from the valve opening in a direction in which the closure element can be first peeled off from the smallest cross sectional region of the valve opening.

The peeling off from the closure element at the smallest cross sectional area initially allows a flowing off of the liquid to be drained, and requires a low valve opening force in the process. Due to the pressure equalization described above, which is caused by the flowing out of the liquid through the opened partial cross section of the valve opening cross sectional area q_{A}, the valve opening force for the remaining larger partial cross section of the valve opening cross-sectional area q_{A} to be opened can be reduced.

Different sized cross sectional regions are initially understood to be regions with different cross sectional areas. The existence of different cross sectional regions per se is defined by the fact that it means cross sectional regions which are geometrically non uniform and thus cannot be described as a unit with common geometric shapes.

Such differently sized cross sectional regions can, for example, be designed as a keyhole shape.

The cross sectional area of the valve opening will preferably have a circular shape. But other geometric shapes of the valve opening are also imaginable, for example, polygonal or elliptical shapes. Furthermore, the valve opening can also have geometrically untypical shapes, which, for example, have a such profile that the opening force of the closure element during successive opening of the valve opening cross sectional area q_{A} of the valve opening permits the lowest force progression over the entire opening path of the closure element. In particular, starting from a first opening point along a peeling direction along which the valve opening cross-sectional area is opened, the cross-sectional shape can widen less than a comparable circular cross section of a circular valve opening, at least in a first partial area.

In one embodiment, the float valve has several valve openings and the valve openings can be closed and opened by a common closure element.

The advantage of providing several valve openings is that a redundancy is provided, also if one opening of the several valve openings is clogged, for example, due to particles. Thus, the probability of a failure of the float valve is lower than with a design with only one valve opening.

In the float valves of the State of the Art, several closure elements are necessary for this purpose in order to have a closure element for each valve opening. According to the invention, however, all closure elements can be closed and opened by means of one closure element, in order to simplify the design of the float valve despite several valve openings.

Furthermore, by successively opening the valve opening cross sectional area q_{A} of the individual valve openings, it can be made possible by the design not to increase the valve opening force required for opening several valve openings compared with the opening of a single valve opening. This can be achieved, for example, by a linear arrangement of the individual valve openings which are opened serially one after the other.

Preferably, the float is directly controlling the closure element without the aid of a pilot valve.

Due to the lower opening forces required as a result of the invention, pilot controls, such as the float valves from the State of the Art, mentioned at the beginning, can be dispensed with. In this way, the closure element can be controlled exclusively by means of the float, and the disadvantages associated with a pilot control are avoided.

It is also a subject matter of the invention to provide a compressed air system, in particular for providing compressed air for the compressed air operation of dental equipment, having one of the preceding float valves according to the invention.

It is also a subject matter of the invention to provide a dryer for a compressed air system having one of the preceding float valves according to the invention.

The float valve according to the invention can also be used in other applications in which a drain is to be closed temporarily and opened temporarily. This applies, for example, to a flushing mechanism.

### BRIEF DESCRIPTION OF THE DRAWINGS

Embodiments of the invention are explained in more detail below with reference to the drawings. These show:

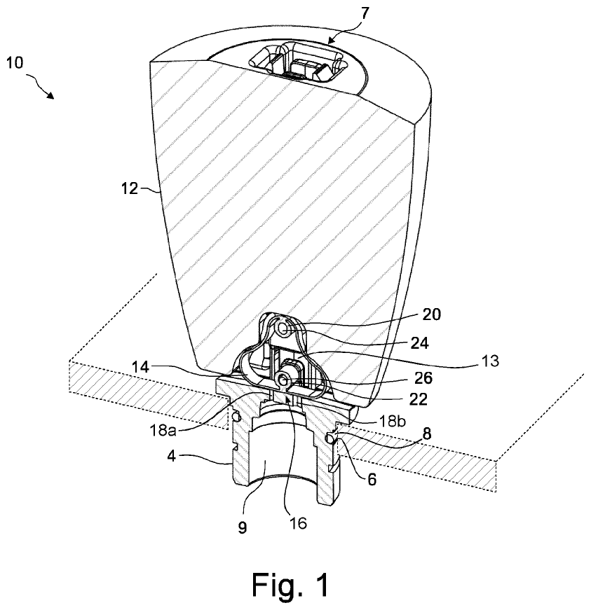

FIG. 1 is a perspective sectional view of a float valve according to the invention in a fully closed position Y in accordance with a first embodiment;

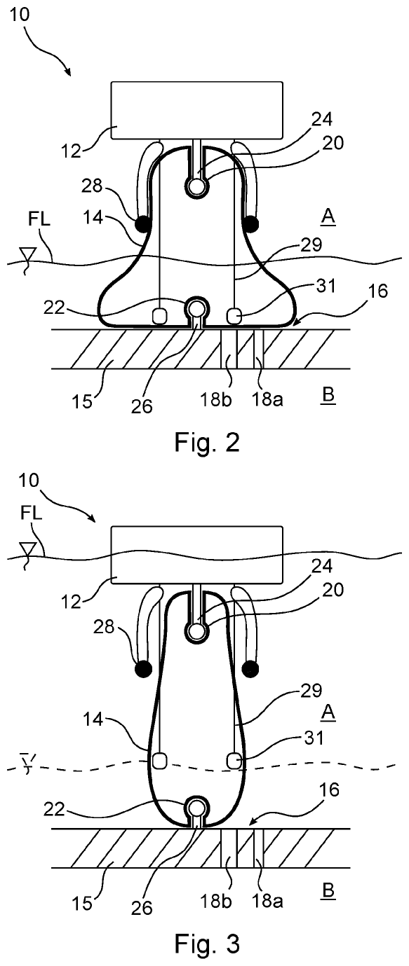

FIG. 2 is a schematic representation of the float valve of FIG. 1 in the fully closed position Y;

FIG. 3 is a schematic representation of the float valve from FIGS. 1 and 2 in a fully opened position X;

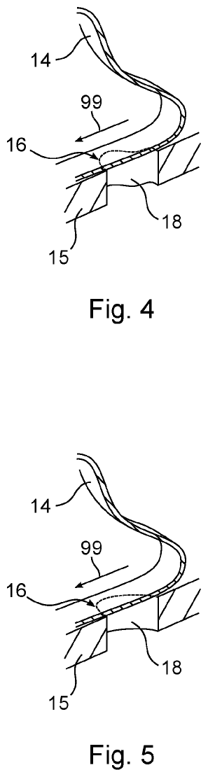

FIG. 4 is a perspective centerline sectional view of a float valve with an advantageously shaped valve opening;

FIG. 5 is a perspective centerline sectional view of a float valve with a valve opening shape designed in a different way;

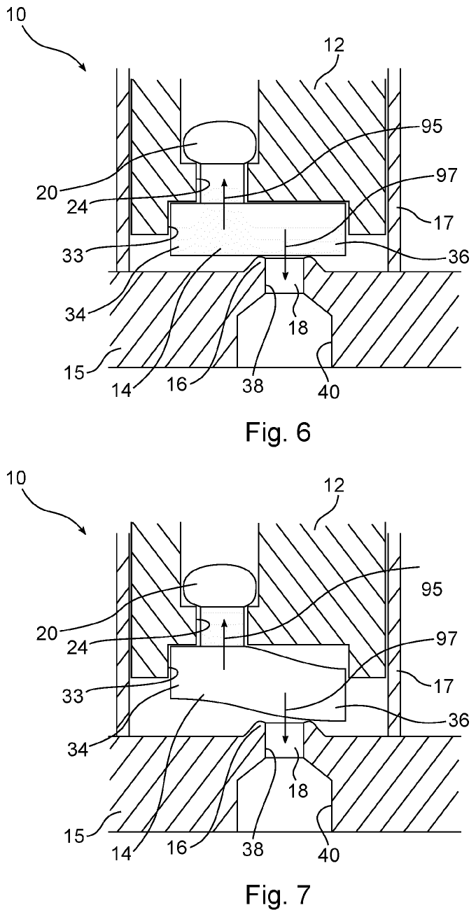

FIG. 6 is a float valve according to the invention in the fully closed position Y in accordance with a second embodiment;

FIG. 7 is a float valve according to the invention in the fully opened position X in accordance with the second embodiment.

### DESCRIPTION OF PREFERRED EMBODIMENTS

FIG. 1 shows a float valve 10 according to the invention for draining liquids in accordance with a first embodiment with a float 12, which can move along a guide rod 13, which is only difficult to recognize in FIG. 1, and an elastic closure element, which is connected to the float 12, which is designed as a strap 14 in accordance with the first embodiment, but can also have other shapes in detail.

In order to guide the float 12 during movement, the float 12 comprises a guide device 7 for receiving the guide rod 13.

In FIG. 1, the float valve 10 shown here is arranged below the strap 14 and has a valve seat 16 which is connected to a drain port 4. Two valve openings 18a, 18 are formed here in the valve seat, which together define a valve opening cross sectional area q_{A}. But only one valve opening 18 or several valve seats can also be provided.

The drain port 4 comprises a circumferential groove 6 for receiving a seal 8, in order to seal off the drain port 4, for example, against a dryer housing 3 of a compressed air system, which dryer housing is only shown by dashed lines in FIG. 1. The liquid to be drained can be discharged via the drain conduit 9 formed in the drain port 4, for example, into a drain reservoir or a sewer system.

But the drain port 4 can also be part of a housing, which is not shown in FIG. 1, for collecting the liquid to be drained.

According to the first embodiment, the closure element is designed as a closed strap 14, which is attached to the float 12 and/or to the valve seat 16 via retaining means 24, 26 which are attached to the float 12 and/or to the valve seat 16.

The retaining means 24, 26 are received by corresponding retaining means receptacles 20, 22 formed on the strap 14. Alternatively, the strap 14 can also be tensioned around the retaining means 24, 26 without retaining means receptacles 20, 22, and thus also be fixed.

Furthermore, a variant is also possible in which the retaining means 26 located at the valve seat 16 as well as the associated retaining means receptacle 22 are not present. Accordingly, the strap 14 is then running virtually straight through at the valve seat 16.

The float valve 10 and its function are explained in more detail using the schematic FIGS. 2 and 3.

The float valve 10 shown in FIGS. 2 and 3 drains liquid FL from an atmosphere A into an atmosphere B. d

In atmosphere B, there is essentially ambient pressure. There is overpressure in atmosphere A, if the float valve 10 is used on a compressed air system. But there may also be ambient pressure in atmosphere A, if the float valve 10 is not used on a compressed air system.

The valve seat 16 defining the two valve openings 18a, 18b with a valve opening cross sectional area q_{A} is formed in a separation material 15. As it is shown in FIG. 1, the separation material 15 may be a face cover on the drain port 4. But the separation material 15 may also be a wall of a valve housing defining a cavity in which the float 12 and the strap 14 are arranged. In this context, the cavity may serve to collect the liquid to be drained.

As is shown in FIGS. 2 and 3, the two valve openings 18a, 18b may have different valve opening cross sectional areas.

The strap 14 is shown in FIG. 2 in the fully closed position Y, in which the strap 14 rests on the valve seat 16 and thus closes the entire valve opening cross sectional area q_{A} of the valve openings 18a, 18b.

In position Y, the strap 14 prevents an exchange of medium between atmosphere A and atmosphere B, at least with regard to the liquid FL.

In contrast to the illustration in FIG. 1, the float valve 10 according to FIGS. 2 and 3 has guide elements 28 still lying on the outside of the float 12 which serve to guide the strap 14 during movements and to place it looped over each other on the valve seat 16. The guide elements 28 can be, for example, only round rods aligned transversely to the strap 14 (filled circle in FIGS. 2 and 3). But the guide elements 28 can also provide an outer shape to the strap 14 over a more extended area, as it is shown in the figures.

In the example shown here, the guide elements 28 are each connected to the float 12 via a support structure 29, so that they move with the float 12, in order to avoid greater frictions of the strap 14 against the guide elements 28.

In addition, the support structure 29 carries a hold-down device 31 which is located within the area enclosed by the strap 14.

In FIG. 2, there is only a low liquid level of the liquid FL to be drained in the atmosphere A, which is the reason as to why no hydraulic buoyancy forces are acting on the float 12 which buoyancy forces would exert a vertically upward force on the float 12.

Due to the weight force of the float 12 and the strap 14, and the lack of hydraulic buoyancy force, which would counteract the two weight forces of the float 12 and the strap 14, the strap 14 remains in said position Y closing the valve seat 16.

The hold-down device 31, which is connected to the float 12 via the support structure 29 in a dimensionally stable manner in contrast to the strap 14, additionally holds down the strap 14 in this position Y, that means, presses it against the valve seat 16. This ensures an even more secure closure, wherein the use of a hold-down device 31 is not absolutely necessary.

A further alternative or supplementary improvement of the closure can be brought about by the valve seat 16 being designed outwards in a slightly sloping manner, for example.

In FIG. 3, however, the float valve 10 is in the fully open position X. This is achieved by the fact that the liquid FL has accumulated to a higher liquid level compared with FIG. 2.

The increased liquid level in turn generates a vertically upward buoyancy force at the float 12. As soon as this is greater than the valve opening force, that means, mainly the force acting downwards from the pressure difference between atmosphere A and atmosphere B as well as the weight force of the float 12 and the strap 14, the float 12 is moved vertically upwards. This causes the float 12 to pull on the upper part of the strap 14. In addition to that, the hold-down device 31 is lifted off the strap 14, so that the strap 14 regains its own freedom of movement.

Since the strap 14 is placed twice over the valve seat in a loop, pulling the part of the strap 14, which lies on top in the loop automatically removes the strap 14 from the valve seat in a peeling manner. As a result, the valve openings 18a, 18b are successively opened both in themselves and one after another, whereby the valve opening cross sectional area q_{A} is also successively opened, so that the liquid is gradually drained with less resistance in the float valve 10.

Due to the partial pressure equalization between the two atmospheres A and B, which also occurs in the process, the pressure difference is reduced, so that the valve opening force is also reduced. Accordingly, a buoyancy force, which becomes smaller, for example, due to the drop in the liquid level, is sufficient to open the float valve 10 further and/or to continue to keep it open.

The strap 14 is in the fully released position X shown in FIG. 3, when the entire valve opening cross sectional area q_{A} of the respective valve openings 18a, 18b is fully opened.

In FIGS. 4 and 5, using the example of the strap 14 as a closure element, different shapes of a valve opening 18 are shown here which can be provided instead of or also for the individual valve openings 18a, 18b.

In this way, FIG. 4 shows a valve opening 18, the cross sectional shape of which corresponds approximately to a rounded keyhole. It can be seen in this context that the keyhole is aligned in such a way that, in the direction of the valve opening 99, a narrower extension area is followed by a wider main opening area.

FIG. 5 shows a variant in which the cross sectional shape is a rounded triangle which widens from a corner in the direction of the valve opening 99.

The decisive factor for the two cross sectional shapes of a valve opening 18 shown, which are advantageous compared with a usual round cross sectional shape, is that an area, which is, transversely to the valve opening direction 99, as narrow as possible with respect to the valve opening direction 99, lies on the side starting from which the strap 14 and/or the closure element is peeled off the valve seat. This allows the valve opening cross sectional area, which is opened, to increase to the same extent as the valve opening force decreases due to the pressure compensation.

FIGS. 6 and 7 show a float valve 10 according to the invention, in accordance with a further embodiment, comprising a float 12 and a resilient closure element 14 connected to the float 12 for draining liquids from an atmosphere A into an atmosphere B.

In this connection, structurally or functionally similar components are provided with the same reference numerals as in the above embodiments.

As in the previous embodiments, the float valve 10 comprises a valve seat 16 formed on a separation material 15 which defines a valve opening 18 having a valve opening cross sectional area q_{A}.

In contrast to the above embodiments, the closure element is not formed as a strap, but as a geometrically simple element, for example, as a substantially round disk 14 which rests on the valve seat 16.

The disk 14 is at least partially received in a recess 33 at the lower end of the float 12 in such a way that the float 12 pulls the disk 14 with it during its upward movement. For this purpose, the disk 14 has a molded on knob 20 as a retaining means receptacle which is clipped into a hole 24 as a retaining means at the bottom of the recess 33.

In this context, the knob 20 is arranged on a first section 34 of the disk 14, so as to be off-centre from the centre of the valve seat 16, so that the effective axis 95 of the buoyancy force of the float 12 does not coincide with the effective axis 97 of a force holding the float valve 10 closed at the valve seat 16. This is most easily achieved by the knob 20 and the is valve seat 16 being offset parallel to each other, wherein the positioning of the disk 14 above the valve seat can be achieved via a housing 17 in which the float 12 is guided.

On a section 36 of the disk 14 opposite the valve seat 16, this is shown here unattached, although an attachment would also be imaginable. The decisive factor is that, due to the elasticity of the disk 14, the section 34 can be moved independently of the section 36, in particular, it can be lifted off the valve seat 16, while the section 36 still rests on the valve seat 16.

Furthermore, the valve opening 18 comprises an expanding flow cross section in the direction of flow from atmosphere A to atmosphere B with flow areas 38, 40, wherein the flow area 38 lies upstream of the flow area 40 in the direction of flow and has a smaller cross section than the cross section of the flow area 40. The flow area 38 merges conically into the flow area 40. But a uniform cross section across both flow areas 38, 40 is just as imaginable as a tapering from atmosphere A to atmosphere B.

The relevant valve opening cross sectional area q_{A}, which is closed and opened by the disk 14, is located at the junction point directly at the valve seat 16. Consequently, the valve opening cross sectional area q_{A} substantially corresponds to the cross section of the flow area 38.

The valve seat 16 protrudes from the separation material 15 in the embodiment of FIGS. 6 and 7. Accordingly, in the closed position Y, the disk 14 only rests on the protruding valve seat 16, but not on the other sections of the separation material 15. But a flat surface without a protruding section of the valve seat 16 is also imaginable.

In contrast to FIG. 6, in FIG. 7, the liquid FL has again accumulated to a higher liquid level. As described with respect to FIG. 3, this exerts a vertically upward buoyancy force on the float 12, so that the float 12 and thus also the disk 14 move vertically upward as a result.

Due to the point of application of the buoyancy force eccentric to the valve seat 16, the section 34 of the disc 14 located at the knob 12 is initially lifted. The valve opening cross sectional area q_{A} is successively opened in the process, so that the accumulated liquid can be discharged via the gradually increasing opened cross sectional region of the valve opening cross sectional area q_{A}.

As it has already explained above, the required valve opening force then decreases due to the partial pressure equalization, and the disk 14 is gradually lifted off the valve seat 16 from the section 34 towards the section 36. In this way, the disk 14, as an exemplary closure element of the float valve 10, also moves from the fully closed position Y to the fully opened position X without the entire, maximum valve opening force having to be applied all at once, as it is the case with a rigid closure element.

1. A float valve, comprising:
a) a float;
b) a valve seat which defines a valve opening having a valve opening cross sectional area q_{A}; and
c) a closure element for opening and closing the valve opening cross sectional area q_{A} of the valve opening, wherein the closure element can be controlled by means of the float between a completely open position X and a completely closed position Y;
wherein
the closure element is elastic and is part of a partial opening mechanism which is designed to successively open the valve opening cross sectional area q_{A} of the valve opening between the completely closed position Y and the completely open position X as a result of the elasticity of the closure element.

2. The float valve according to claim 1, wherein the elastic closure element comprises, at least in sections, a strap for opening and closing the valve opening cross sectional area q_{A} of the valve opening, the strap being designed to be peeled off from the valve opening between the fully closed position Y and the fully opened position X, in order to successively open the valve opening cross sectional area q_{A} of the valve opening by the removal in a peeling manner.

3. The float valve according to claim 2, wherein one retaining means each is provided on the float and/or on the valve seat, by means of which the strap can be attached to the float and/or to the valve seat.

4. The float valve according to claim 2, wherein the strap is a closed strap.

5. The float valve according to claim 1, wherein the closure element can be positioned eccentrically to the valve opening at least in the fully closed position Y, and can be attached to the float in such a non-uniform manner that, when the closure element is controlled between the fully closed position Y and the fully opened position X, the closure element is removed from the valve opening in a peeling manner, and the valve opening cross sectional area q_{A} of the valve opening is successively opened by the removal in a peeling manner.

6. The float valve according to claim 1, wherein the valve opening each has several cross sectional regions of different size, wherein the closure element can be peeled off from the valve opening in a direction in which the closure element can be first peeled off from the smallest cross sectional region of the valve opening.

7. The float valve according to claim 1, wherein the float valve has several valve openings and the valve openings can be closed and opened by a common closure element.

8. The float valve according to claim 1, wherein the float is directly controlling the closure element without the aid of a pilot valve.

9. A compressed air system, configured to provide compressed air to dental equipment, the system comprising a float valve of claim 1.

10. A dryer for a compressed air system, the dryer comprising a float valve of claim 1, the float valve configured to drain condensate.
